(19) United States
(12) Patent Application Publication
(10) Pub. No.: US 2026/0253081 A1
(43) Pub. Date: Aug. 27, 2026

(54) CONFIGURATION-DRIVEN AUTHORIZATION REQUEST PROCESSING

(71) Applicant: Capital One Services, LLC, McLean, VA (US)

(72) Inventors: Raja CHATTOPADHYAY, Glen Allen, VA (US); Walker SENSABAUGH, Henrico, VA (US); Kyle HEIDE, Midlothian, VA (US); Margaret COOK, Chicago, IL (US); William A. BIGGINS, Glen Allen, VA (US); Tyler O'CONNELL, Richmond, VA (US); Rakesh KOUL, Glen Allen, VA (US); Nicholas MAGUIRE, Crozier, VA (US); Krystle C. VOSS, Richmond, VA (US); Taimore KHAN, Richmond, TX (US); Senthil K. SURIYANARAYANAN, Glen Allen, VA (US); Robert C. STETTLER, Powhatan, VA (US); Harold A. SELL, Glen Allen, VA (US); Anna ROSS, Chicago, IL (US); Erin KIRBY, Glen Allen, VA (US); Benjamin CHRISTENSON, Minneapolis, MN (US); Jason BAUMGARTNER, Richmond, VA (US)

(21) Appl. No.: 19/061,625

(22) Filed: Feb. 24, 2025

(51) Int. Cl. G06Q 20/40

(52) U.S. Cl. CPC G06Q 20/405

(57) ABSTRACT

In some implementations, a device may retrieve a configuration associated with processing a request. The device may perform, based on service call information included in the configuration, one or more service calls to retrieve input data associated with processing the request. The device may perform, based on the input data and field mapping information included in the configuration, one or more field mappings to create output data. The device may evaluate the output data based on one or more rule sets indicated in the configuration to determine a decision associated with the request. The device may provide a response based on the decision.

### BACKGROUND

A configuration-driven device is a device that operates based on a configuration (e.g., a set of predefined and/or dynamically adjustable settings), rather than hard-coded instructions. Thus, functionality of a configuration-driven device is determined by the configuration, which can be modified without altering underlying code. This approach enhances flexibility, scalability, and adaptability of the device, which allows a given device to support a variety of use cases or environments through adjustment of the configuration.

### SUMMARY

Some implementations described herein relate to a device for configuration-driven authorization request processing. The device may include one or more memories and one or more processors communicatively coupled to the one or more memories. The one or more processors may be configured to obtain an authorization request. The one or more processors may be configured to retrieve a configuration associated with processing the authorization request, wherein the configuration indicates service call information, field mapping information, and one or more rule sets. The one or more processors may be configured to perform, based on the service call information included in the configuration, one or more service calls to obtain source data associated with processing the authorization request. The one or more processors may be configured to perform, based on the source data and the field mapping information included in the configuration, one or more field mappings to generate decision data. The one or more processors may be configured to evaluate the decision data based on the one or more rule sets indicated in the configuration to determine an authorization decision associated with the authorization request. The one or more processors may be configured to generate an authorization response based on the authorization decision. The one or more processors may be configured to provide the authorization response.

Some implementations described herein relate to a method for configuration-driven request processing. The method may include retrieving, by a device, a configuration associated with processing a request. The method may include performing, by the device and based on service call information included in the configuration, one or more service calls to retrieve input data associated with processing the request. The method may include performing, by the device and based on the input data and field mapping information included in the configuration, one or more field mappings to create output data. The method may include evaluating, by the device, the output data based on one or more rule sets indicated in the configuration to determine a decision associated with the request. The method may include providing, by the device, a response based on the decision.

Some implementations described herein relate to a non-transitory computer-readable medium that stores a set of instructions. The set of instructions, when executed by one or more processors of a device, may cause the device to retrieve a configuration associated with processing an authorization request, wherein the configuration indicates service call information, field mapping information, and one or more rule sets. The set of instructions, when executed by one or more processors of the device, may cause the device to perform, based on the service call information included in the configuration, one or more service calls to obtain source data associated with processing the authorization request. The set of instructions, when executed by one or more processors of the device, may cause the device to perform, based on the source data and the field mapping information included in the configuration, one or more field mappings to generate decision data. The set of instructions, when executed by one or more processors of the device, may cause the device to evaluate the decision data based on the one or more rule sets indicated in the configuration to determine an authorization decision associated with the authorization request. The set of instructions, when executed by one or more processors of the device, may cause the device to perform, based on the configuration and after evaluating the decision data, one or more post-decision service calls or one or more post-decision field mappings in association with generating an authorization response. The set of instructions, when executed by one or more processors of the device, may cause the device to provide the authorization response.

### BRIEF DESCRIPTION OF THE DRAWINGS

FIGS. 1A-1C are diagrams of an example associated with configuration-driven authorization request processing, in accordance with some embodiments of the present disclosure.

FIG. 2 is a diagram of an example environment in which devices, systems, and/or methods described herein may be implemented, in accordance with some embodiments of the present disclosure.

FIG. 3 is a diagram of example components of a device associated with configuration-driven authorization request processing, in accordance with some embodiments of the present disclosure.

FIG. 4 is a flowchart of an example process associated with configuration-driven authorization request processing, in accordance with some embodiments of the present disclosure.

### DETAILED DESCRIPTION

The following detailed description of example implementations refers to the accompanying drawings. The same reference numbers in different drawings may identify the same or similar elements.

A user of a transaction medium (e.g., a transaction card) may attempt to perform a transaction using the transaction medium. Such a transaction needs to be authorized by an entity (e.g., a financial institution) that manages an account associated with the transaction medium. In general, a process for authorization of a transaction may include verifying validity of the transaction, ensuring that the transaction medium is active, ensuring (e.g., using an open-to-buy (OTB) calculation) that the account and/or transaction medium is within an applicable limit, ensuring that the transaction is free from fraud, or the like.

Conventionally, an entity relies on an external (e.g., third-party) system for processing of requests for authorizations associated with transactions. However, reliance on an external system is disadvantageous for a number of reasons. For example, innovation and adaptation with respect to evolving needs associated with authorization request processing is difficult or impossible because the entity does not have control of the processing system. Further, authorization process flows as conventionally implemented are tightly coupled with a specific transaction division (e.g., credit, debit, trade credit, small business, or the like) and the associated specific data models, data fields, and rule sets, which are hard-coded external to the authorization request processing system. This rigid authorization process flow implementation structure hampers flexibility and adaptability of the authorization request processing system with respect to support for different transaction divisions. As a result, accommodation of authorization process flows for different transaction divisions and onboarding of authorization process flows for new transaction divisions are challenging.

Some implementations described herein provide configuration-driven authorization request processing. In some implementations, a cell-based authorization request processing system is used for processing of authorization requests. In one example, the cell-based authorization request processing system comprises a plurality of cells (e.g., separate authorization request processing devices) and one or more routing devices. In operation, an authorization request is routed to a cell, and the cell retrieves a configuration associated with processing the authorization request. As described herein, the configuration may indicate service call information, field mapping information, and one or more rule sets associated with processing the authorization request. The cell may then perform, based on the service call information, one or more service calls to obtain source data associated with processing the authorization request. The cell then performs one or more field mappings to generate decision data based on the source data and the field mapping information. The cell then evaluates the decision data based on the one or more rule sets to determine an authorization decision, and generates and provides an authorization response based on the authorization decision. The configuration-driven approach defines how a cell-based authorization request processing systems obtains data, transforms the data, performs authorization decisioning on the transformed data, and returns an authorization response to be defined according to a configuration (e.g., rather than hard-coded).

In some implementations, the techniques and apparatuses described herein provide separation of power between transaction divisions and a transaction base (e.g., a set of data models, rule sets, or the like, common to or shared by multiple divisions), meaning that an extent to which modifications needed to support a given transaction division require change to the transaction base is limited. This enables an authorization processing flow for a given transaction division to be configured (e.g., a transaction-division-specific data model, a transaction-division-specific rule set, a transaction-division-specific service call, or the like) as-needed, without a need to coordinate modifications with the transaction base. Similarly, the techniques and apparatuses described herein provide separation of responsibilities, meaning that a need to modify code associated with the transaction base by a given transaction division is reduced or eliminated, and that modifications to code associated with the transaction base do not necessitate updates associated with a given transaction division.

Further, the techniques and apparatuses described herein do not use transaction-division-specific logic, meaning that no modification to an authorization flow associated with a specific transaction division would require another transaction division to update its authorization process flow implementation. Similarly, the techniques and apparatuses described herein provide isolation of transaction-division-specific changes, meaning that a modification to an authorization process flow associated with one transaction division would not require updates or modifications of another transaction division authorization process flow, thereby ensuring that authorization process flows associated with different transaction divisions operate independently.

Additionally, the techniques and apparatuses described herein provide standardization, meaning that operations or processes common across multiple transactions divisions can be standardized. Furthermore, the techniques and apparatuses described herein ease onboarding of transaction divisions, meaning that complexity of domain-specific knowledge required for a transaction division to be integrated in the cell-based authorization request processing system is minimized. Additional details are provided below.

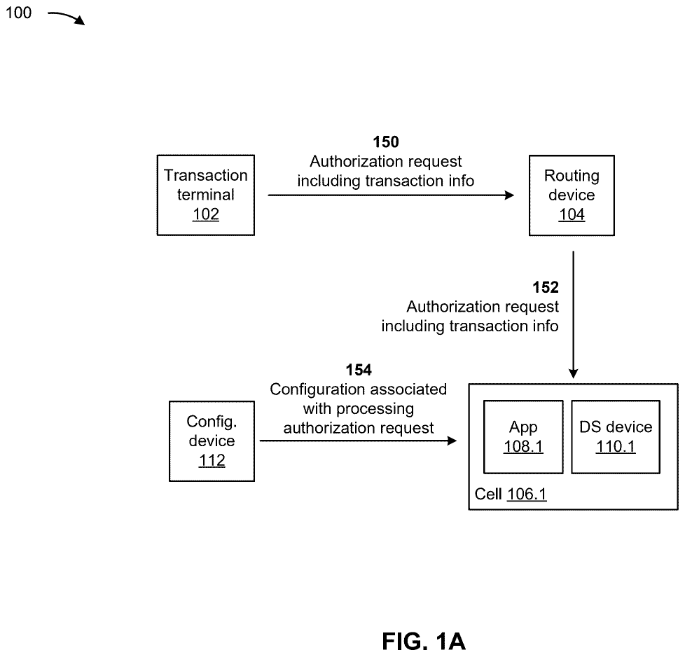

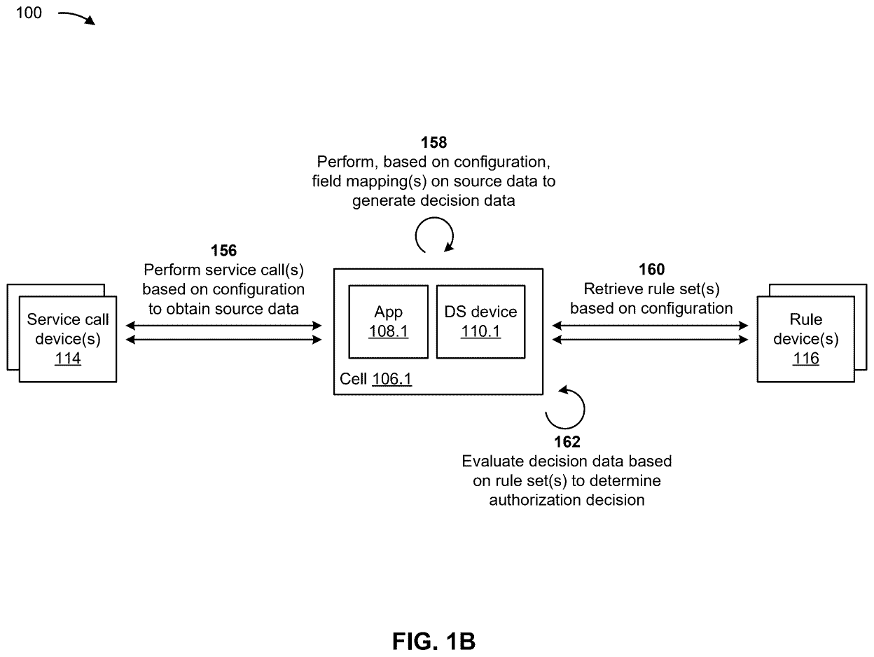

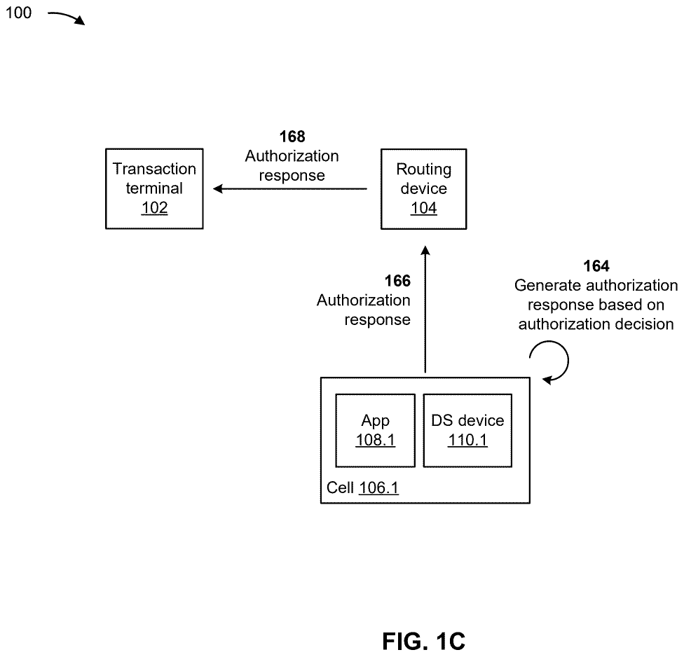

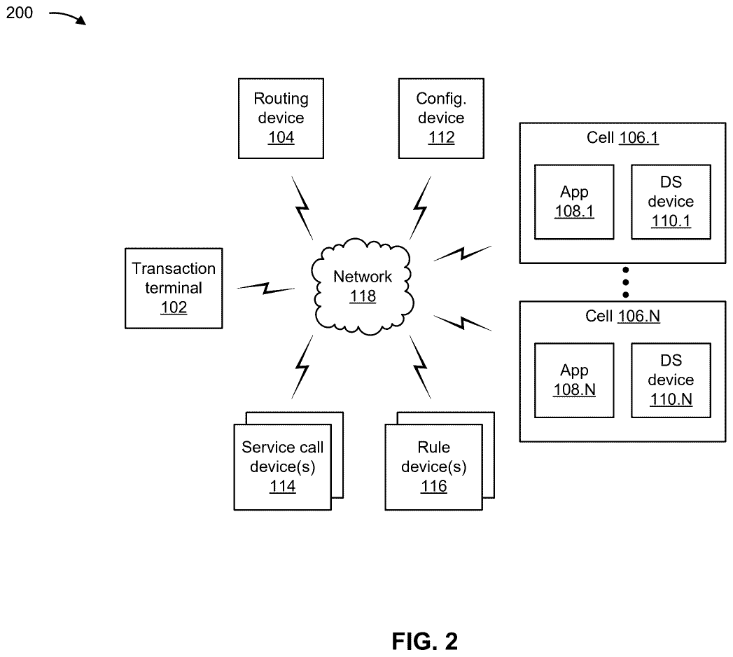

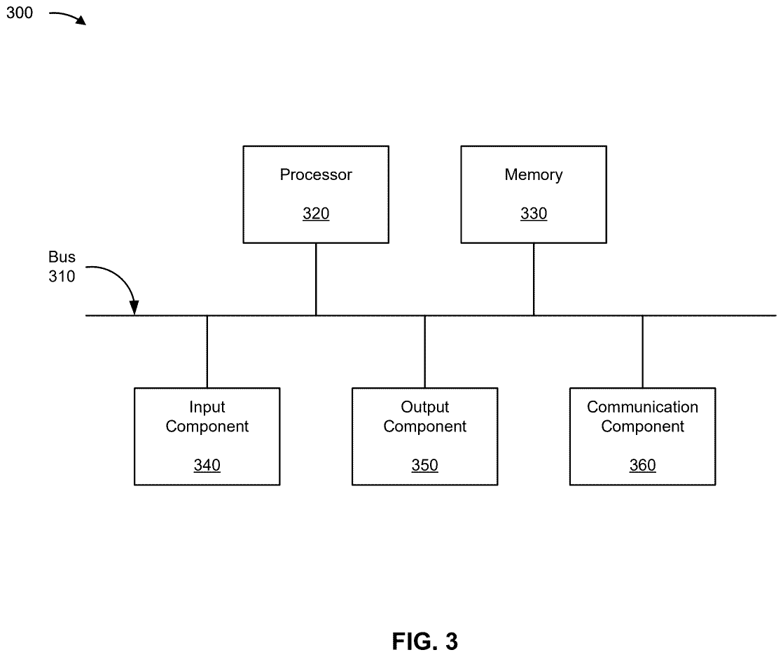

FIGS. 1A-1C are diagrams of an example 100 associated with configuration-driven authorization request processing. As shown in FIGS. 1A-1C, example 100 includes a transaction terminal 102, a routing device 104, a cell 106.1 comprising an application component 108.1 and a data structure device 110.1, a configuration device 112, one or more service call devices 114, and one or more rule devices 116. These devices are described in more detail in connection with FIGS. 2 and 3.

As shown at reference 150 in FIG. 1A, the transaction terminal 102 may provide, and the routing device 104 may receive, an authorization request including transaction information.

The transaction information includes information associated with a transaction for which authorization is requested by the authorization request. The transaction information may include, for example, a medium credential (e.g., a transaction card number), an account credential (e.g., an account number) associated with the medium credential, a value associated with the transaction (e.g., a purchase amount), or the like.

In some implementations, as noted above, the authorization request may include a medium credential, and the routing device 104 may identify an account credential associated with the medium credential. For example, the routing device 104 may store or have access to information that maps medium credentials to account credentials, and may identify an account credential associated with the medium credential based on this information.

As shown at reference 152, a cell 106.1 may obtain the authorization request. For example, the routing device 104 may provide, and the cell 106.1 may receive, the authorization request. In some implementations, the routing device 104 may select the cell 106.1 for processing the authorization request. For example, the routing device 104 may identify a pool of cells 106 that are associated with the account credential, with the pool of cells 106 including the cell 106.1. The routing device 104 may then select the cell 106.1 as a target cell 106 for processing of the authorization request. Thus, in some implementations, the cell 106.1 may obtain the authorization request based on an association of the cell 106.1 with one or more credentials. In this way, authorization requests associated with a given account credential may be routed to a particular set of cells 106 for processing in the cell-based authorization request processing system.

As shown at reference 154, the cell 106.1 may retrieve a configuration associated with processing the authorization request. For example, the cell 106.1 may retrieve, or otherwise obtain, the configuration from the configuration device 112 (e.g., a device configured to receive, store, or provide configurations associated with authorization request processing by cells 106 in a cell-based authorization request processing system). In some implementations, the configuration indicates service call information, field mapping information, and one or more rule sets.

The service call information includes information associated with one or more service calls to be performed by the cell 106.1 with respect to processing the authorization request. In general, a service call is an operation that enables a cell 106.1 to obtain information to be used by the cell 106.1 in association with processing the authorization request. For example, the one or more service calls may enable the cell 106.1 to obtain source data based on which the authorization request will be processed. In a particular example, the source data may include a credit limit associated with the account credential or the medium credential, a total balance value associated with the account credential or the medium credential, a total outstanding value associated with the account credential or the medium credential, a tokenized medium credential (e.g., a tokenized transaction card number) corresponding to the medium credential, or the like.

In some implementations, the service call information may indicate one or more data models based on which the service call is performed. In some implementations, a given data model may be a transaction-division-specific data model (e.g., a data model specific to a particular transaction division), or may be a base transaction data model (e.g., a data model shared by or common to a plurality of transaction divisions). In some implementations, the service call information may include information associated with a plurality of service calls (e.g., when the cell 106.1 is to perform multiple service calls in association with performing authorization request processing).

In some implementations, the configuration may indicate a service call condition. A service call condition is a condition that dictates whether a service call, as indicated in the configuration, is performed by a cell 106. For example, the field mapping condition may be associated with a message type or code indicated in the authorization request (e.g., such that the cell 106.1 performs the service call only if a message type of the authorization request is “REQUEST,” such that the cell 106.1 performs the service call only if a code associated with the authorization request indicates “PURCHASE,” or the like). In some implementations, each service call indicated in the service call information may have one or more associated service call conditions.

In some implementations, the configuration may indicate an order, sequence, or priority based on which the one or more service calls are to be performed by the cell 106.1. For example, the service call information may indicate that a first service call and a second service call are to be performed by the cell 106.1, and may further indicate that the second service call is to be performed after a performance of the first service call is completed (e.g., such that the first service call is completed prior to the second service call being initiated). As another example, the service call information may indicate that two or more service calls can be performed concurrently or independently of one another. As a particular example, the service call information may indicate that a first service call and a second service call are to be performed by the cell 106.1, and can be performed concurrently with one another.

The field mapping information may include information associated with one or more field mappings (e.g., data transformations) to be performed by the cell 106.1 with respect to source data obtained by the cell 106.1 based on the one or more service calls. A field mapping is a manipulation of input data (e.g., source data) to generate output data (e.g., decision data based on which authorization decisioning can be performed). In a particular example, a field mapping may comprise computing an OTB value associated with the account credential based on the credit limit associated with the account credential or the medium credential, the total balance value associated with the account credential or the medium credential, and the total outstanding value associated with the account credential or the medium credential. In this example, the source data comprises the credit limit, the total balance value, and the total outstanding value, while the decision data comprises the OTB value. In some implementations, the field mapping information may include information associated with a plurality of field mappings (e.g., when the cell 106.1 is to perform multiple data transformations in association with generating the decision data).

In some implementations, the configuration may indicate a field mapping condition. A field mapping condition is a condition that dictates whether a field mapping, as indicated in the configuration, is performed by a cell 106. For example, the field mapping condition may be associated with determining that the requisite source data was obtained via the one or more service calls message types or code indicated in the authorization request (e.g., such that the cell 106.1 performs the field mapping only if all service calls were successfully completed, such that the cell 106.1 performs the field mapping only if all source data as defined by the service call information was obtained). In some implementations, each field mapping indicated in the field mapping information may have one or more associated field mapping conditions.

A rule set includes rules based on which a cell 106 evaluates decision data (e.g., generated as a result of the one or more field mappings) in association with determining an authorization decision associated with the authorization request. That is, the rule set includes one or more rules based on which the cell 106 performs authorization decisioning associated with the authorization request (e.g., whether the transaction is authorized). In some implementations, the one or more rule sets may include a base rule set for processing authorization requests (e.g., a rule set used for authorization request processing flows of multiple transaction divisions). Additionally, or alternatively, the one or more rule sets may include a transaction-division-specific rule set for processing authorization requests.

In this way, the configuration indicates a manner in which the cell 106.1 is to process the authorization request, with the one or more service calls, the one or more field mappings, and the one or more rule sets being abstracted in the configuration so that the cell 106.1 may provide an authorization response according to the configuration (e.g., rather than in a manner as defined by hard-coding).

As shown at reference 156 in FIG. 1B, the cell 106.1 (e.g., the app 108.1) may perform, based on the service call information included in the configuration, one or more service calls to obtain source data associated with processing the authorization request. For example, the cell 106.1 may determine that one or more service call conditions, indicated in the configuration, are satisfied (e.g., such that the cell 106.1 is to proceed with the one or more service calls), and may communicate with the one or more service call devices 114 to obtain source data associated with processing the authorization request. In some implementations, the cell 106.1 may perform the one or more service calls based on an order, sequence, or priority, as described above.

Additionally, or alternatively, the cell 106.1 may in some implementations concurrently perform two or more service calls (e.g., when permitted, or as indicated by the configuration, as described above).

As shown at reference 158, the cell 106.1 (e.g., the app 108.1) may perform, based on the source data and the field mapping information included in the configuration, one or more field mappings to generate decision data. For example, the cell 106.1 may determine that one or more field mapping conditions, indicated in the configuration, are satisfied (e.g., such that the cell 106.1 is to proceed with the one or more field mappings), and may perform the one or more field mappings based on the configuration and the source data in order to generate decision data associated with the authorization request.

As shown at reference 160, the cell 106.1 (e.g., the app 108.1) may retrieve the one or more rule sets indicated in the configuration. For example, the cell 106.1 may communicate with the one or more rule devices 116 in order to retrieve the one or more rule sets as indicated in the configuration. In some implementations, as described above, the one or more rule sets may include one or more base rule sets and/or one or more transaction-division-specific rule sets.

As shown at reference 162, the cell 106.1 (e.g., the app 108.1) may evaluate the decision data based on the one or more rule sets indicated in the configuration to determine an authorization decision associated with the authorization request. For example, the cell 106.1 may determine an authorization decision associated with the authorization request (e.g., whether the authorization request is approved). In one example, evaluating the decision data may include determining whether a purchase amount indicated in the authorization request plus the OTB value generated by a field mapping is less than or equal to a credit limit indicated in the source data. Here, a relevant rule may indicate that the authorization is approved if the purchase amount plus the OTB value is less than or equal to the credit limit and, otherwise, that the authorization is not approved.

In some implementations, the cell 106.1 may perform one or more post-decision field mappings. For example, the field mapping information may in some implementations indicate one or more field mappings that are to be performed after evaluation of the decision data by the cell 106.1, and the cell 106.1 may perform the one or more post-decision field mappings accordingly. In one example, the one or more post-decision field mappings may include generating authorization response data (e.g., data indicating the account credential associated with the authorization request, an approved amount associated with the authorization request, a decision status associated with the authorization request, or the like). In some implementations, the authorization response data may be included in an authorization response generated by the cell 106.1 as described below.

In some implementations, the cell 106.1 may perform one or more post-decision service calls. For example, the service call information may in some implementations indicate one or more service calls that are to be performed after evaluation of the decision data by the cell 106.1, and the cell 106.1 may perform the one or more post-decision service calls accordingly. In one example, the one or more post-decision service calls may include one or more service calls associated with storing data associated with the authorization request process (e.g., the approved transaction data generated as a result of the one or more post-decision field mappings).

As shown at reference 164 in FIG. 1C, the cell 106.1 (e.g., the app 108.1) may generate an authorization response based on the authorization decision. For example, the cell 106.1 may generate an authorization response including the authorization response data generated as a result of the one or more post-decision field mappings as described above.

In some implementations, the cell 106.1 may store one or more items of data in a data map. For example, the cell 106.1 may store the authorization request, the source data, the decision data, information associated with the authorization decision, the authorization response data, or the authorization response in a data map, with the data map including an identifier associated with the authorization request (e.g., such that data associated with the authorization request can be accessed or referenced at a later time).

As shown at reference 166, the cell 106.1 may provide the authorization response to the routing device 104 (e.g., the routing device 104 from which the authorization request was received), and as shown by reference 168, the routing device 104 may provide the authorization response to the transaction terminal 102.

In some implementations, the techniques and apparatuses described herein support the use of dynamic values with respect to authorization request processing. For example, configuration values are not static, and may rely on dynamically defined values that come from the authorization request itself. In some implementations, the techniques and apparatuses described herein may use a templating language to support referencing fields in available data (e.g., source data). This also enables calculations and field mappings based on that data to generate new data (e.g., decision data). Additionally, the templating language may support implementation of custom field mappings so as to provide reusable common functionality that can be used to define a field mapping in a scenario in which the template language does not natively support the field mapping or supports the field mapping in an overly complex way.

Additionally, or alternatively, the techniques and apparatuses described herein may utilize (e.g., user-specified) conditions (e.g., service call conditions, field mapping conditions, or the like) that enable definition of scenarios in which one or more operations associated with authorization request processing should be skipped or otherwise not performed.

Additionally, or alternatively, the techniques and apparatuses described herein enable the use of different data models (e.g., different transaction-division-specific data models) without a need to load these different data models into the cell-based authorization request processing system. In some implementations, such enablement is provided by allowing data models to be specified as generated classes with a unique name in a package that is loaded during a build time associated with the cell 106. A given data model can then be referenced in the configuration (e.g., by name) so as to cause the cell 106 to create a new instance of the data model that can then be populated.

Additionally, or alternatively, the techniques and apparatuses described herein enable different rule sets to be used in association with authorization request processing. This capability is supported by allowing a package to specified that loads a desired rule set, and the cell 106 can use the package at runtime to perform checks against the rule set in association with authorization request processing.

Additionally, or alternatively, the techniques and apparatuses described herein enable service calls to performed in a timely manner where, in some cases, one service call may depend on another. This capability can be provided by using a unique name for each service call, and a key (e.g., dependsOn) that specifies one or more other service calls that need to be performed prior to a given service call. Performance of the service calls is then orchestrated by the cell 106 so that some service calls are performed concurrently, while service calls that depend on one or more other service calls are performed after completion of those service calls on which they depend.

Additionally, or alternatively, the techniques and apparatuses described herein enable protection of sensitive data (e.g., data that should not be logged or sent to an analytical service). This capability can be supported by providing a list of data fields that should be masked or removed.

Additionally, or alternatively, the techniques and apparatuses described herein enable protection of “read only” models. In some scenarios, there may be data that should not be modifiable, but that needs to be provided along with data that is modifiable. This capability can be enabled by providing a list of read-only data keys (e.g., the authorization request, responses from the one or more service calls, or the like) and validating the configuration to ensure that a forbidden data write is not performed.

Additionally, or alternatively, the techniques and apparatuses described herein enable adding or consolidating of endpoints and authorization process flows. A user should be able to define a full endpoint for an authorization process flow, as well as remove it. Further, the user should be able to specify any number of authorization process flows under each endpoint. To support this capability, the techniques and apparatuses described herein use a top-level portion of a configuration to list all possible endpoints, and under each, include a list of authorization process flows that an authorization request will be matched against (e.g., to find the appropriate authorization process flow).

Additionally, or alternatively, the techniques and apparatuses described herein may deploy an abstracted service alongside user-defined elements. For example, abstracting away base-specific information into a configuration is meaningless if all base-specific elements are in a shared repository. To address this issue, the techniques and apparatuses described herein may create a base “image” that includes the abstracted code, which can then be used by a base-specific repository as a base for an image. That image may also load in other portions (e.g., data models, rule sets, configurations, or the like), and conduct testing before deployment.

Additionally, or alternatively, the techniques and apparatuses described herein may support validation of a configuration format and values. To avoid a configuration that does not work with the cell-based authorization request processing system, the techniques and apparatuses described herein may use a series of schema validations as well as logical validations that can stop a broken configuration from being used.

Additionally, or alternatively, the techniques and apparatuses described herein may support improved performance. A change from having an authorization request process flow written in code to needing the code to check a configuration may increase an amount of time needed to perform authorization request processing. In some implementations, to address this issue, the techniques and apparatuses described herein implement asynchronous service calls (e.g., such that service calls that do not depend on others are not delayed and are performed concurrently) and may parallelize field mappings (e.g., such that field mappings are performed concurrently).

Additionally, or alternatively, the techniques and apparatuses described herein may enable a flexible order of operations with respect to authorization process flows. An order of operations with respect to performing authorization request processing may vary among authorization request process flows. To address this issue, the techniques and apparatuses described herein may allow each authorization process flow to be defined as a list of steps, where each step is described by a step type. That step type value can be used to determine a method to be called at a given step.

As indicated above, FIGS. 1A-1C are provided as an example. Other examples may differ from what is described with regard to FIGS. 1A-1C.

FIG. 2 is a diagram of an example environment 200 in which devices, systems, and/or methods described herein may be implemented. As shown in FIG. 2, environment 200 may include a transaction terminal 102, a routing device 104, a plurality of cells 106 (e.g., cell 106.1 through cell 106.N (N>1)) each comprising an associated application component 108 and a data structure device 110, a configuration device 112, one or more service call devices 114, one or more rule devices 116, and a network 118. Devices of environment 200 may interconnect via wired connections, wireless connections, or a combination of wired and wireless connections.

The transaction terminal 102 may include one or more devices capable of facilitating an electronic transaction. For example, the transaction terminal 102 may include a point-of-sale (PoS) terminal, a payment terminal (e.g., a credit card terminal, a contactless payment terminal, a mobile credit card reader, or a chip reader), and/or an automated teller machine (ATM). The transaction terminal 102 may include one or more input components and/or one or more output components to facilitate obtaining data (e.g., an authorization request, transaction information, or the like) from a transaction device (e.g., a transaction card, a mobile device executing a payment application, or the like) and/or to facilitate interaction with and/or authorization from an owner or accountholder of the transaction device. Example input components of the transaction terminal 102 include a number keypad, a touchscreen, a magnetic stripe reader, a chip reader, and/or a radio frequency (RF) signal reader (e.g., a near-field communication (NFC) reader). Example output devices of transaction terminal 102 include a display and/or a speaker.

The routing device 104 may include one or more devices capable of receiving, processing, storing, routing, and/or providing traffic (e.g., an authorization request) in a manner described herein. For example, the routing device 104 may include a router, such as a label switching router (LSR), a label edge router (LER), an ingress router, an egress router, a provider router (e.g., a provider edge router or a provider core router), a virtual router, or another type of router. Additionally, or alternatively, the routing device 104 may include a gateway, a switch, a firewall, a hub, a bridge, a reverse proxy, a server (e.g., a proxy server, a cloud server, or a data center server), a load balancer, and/or a similar device. In some implementations, the routing device 104 may be a physical device implemented within a housing, such as a chassis. In some implementations, the routing device 104 may be a virtual device implemented by one or more computing devices of a cloud computing environment or a data center. In some implementations, a group of routing devices 104 may be a group of data center nodes that are used to route traffic flow through a network.

A cell 106 may include one or more devices capable of receiving, generating, storing, processing, and/or providing information associated with an authorization request and/or performing processing of the authorization request, as described herein. In some implementations, a given cell 106 includes an application component (app) 108 and a data structure (DS) device 110. The application component 108 may include one or more devices capable of receiving, generating, storing, processing, and/or providing information (e.g., data) associated with processing an authorization request in a cell-based authorization request processing system. The application component 108 may include a communication device and/or a computing device. For example, the application component 108 may include a server, such as an application server, a client server, a web server, a database server, a host server, a proxy server, a virtual server (e.g., executing on computing hardware), or a server in a cloud computing system. In some implementations, the application component 108 may include computing hardware used in a cloud computing environment. The data structure device 110 may include one or more devices capable of receiving, generating, storing, processing, and/or providing information (e.g., data) associated with authorization request routing in a cell-based authorization request processing system, as described elsewhere herein. The data structure device 110 may include a communication device and/or a computing device. For example, the data structure device 110 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. In some implementations, the data structure device 110 may include one or more databases.

The configuration device 112 may include one or more devices capable of receiving, generating, storing, processing, and/or providing information related to configuration-driven authorization request processing, as described elsewhere herein. The configuration device 112 may include a communication device and/or a computing device. For example, the configuration device 112 may include a server, such as an application server, a client server, a web server, a database server, a host server, a proxy server, a virtual server (e.g., executing on computing hardware), or a server in a cloud computing system. In some implementations, the configuration device 112 may include computing hardware used in a cloud computing environment.

A service call device 114 may include one or more devices capable of receiving, generating, storing, processing, and/or providing information related to configuration-driven authorization request processing, as described elsewhere herein. The service call device 114 may include a communication device and/or a computing device. For example, the service call device 114 may include a server, such as an application server, a client server, a web server, a database server, a host server, a proxy server, a virtual server (e.g., executing on computing hardware), or a server in a cloud computing system. In some implementations, the service call device 114 may include computing hardware used in a cloud computing environment.

A rules device 116 may include one or more devices capable of receiving, generating, storing, processing, and/or providing information related to configuration-driven authorization request processing, as described elsewhere herein. The rules device 116 may include a communication device and/or a computing device. For example, the rules device 116 may include a server, such as an application server, a client server, a web server, a database server, a host server, a proxy server, a virtual server (e.g., executing on computing hardware), or a server in a cloud computing system. In some implementations, the rules device 116 may include computing hardware used in a cloud computing environment.

The network 118 may include one or more wired and/or wireless networks. For example, the network 118 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 118 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with configuration-driven authorization request processing. The device 300 may correspond to a transaction terminal 102, a routing device 104, a cell 106, an application component 108, a data structure device 110, a configuration device 112, a service call device 114, and/or a rule device 116. In some implementations, a transaction terminal 102, a routing device 104, a cell 106, an application component 108, a data structure device 110, a configuration device 112, a service call device 114, and/or a rule device 116 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

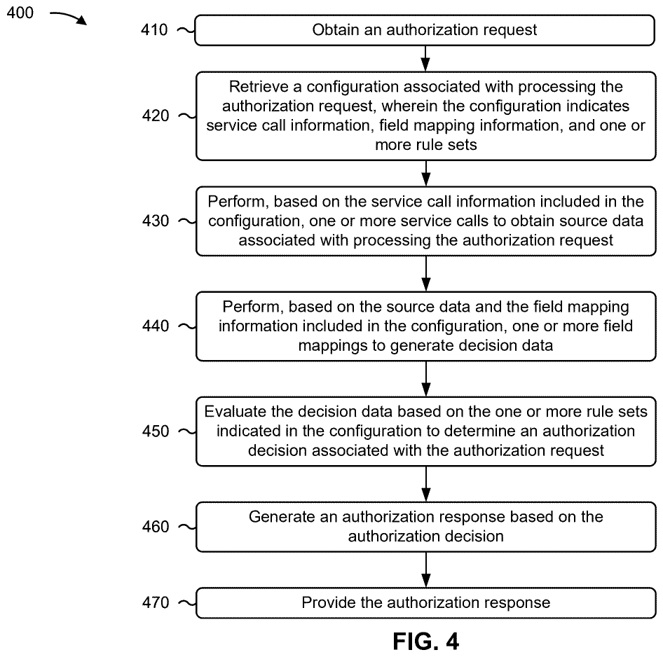

FIG. 4 is a flowchart of an example process 400 associated with configuration-driven authorization request processing. In some implementations, one or more process blocks of FIG. 4 may be performed by the cell 106. In some implementations, one or more process blocks of FIG. 4 may be performed by another device or a group of devices separate from or including the cell 106, such as the transaction terminal 102, the routing device 104, and/or the configuration device 112. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining an authorization request (block 410). For example, the cell 106 (e.g., using processor 320 and/or memory 330) may obtain an authorization request, as described above in connection with reference 152 of FIG. 1A. As an example, the cell 106.1 may obtain an authorization request associated with a medium credential and an account credential.

As further shown in FIG. 4, process 400 may include retrieving a configuration associated with processing the authorization request, wherein the configuration indicates service call information, field mapping information, and one or more rule sets (block 420). For example, the cell 106 (e.g., using processor 320 and/or memory 330) may retrieve a configuration associated with processing the authorization request, wherein the configuration indicates service call information, field mapping information, and one or more rule sets, as described above in connection with reference 154 of FIG. 1A. As an example, the cell 106.1 may retrieve a configuration associated with processing the authorization request associated with the account credential, with the configuration indicating one or more service calls to be performed by the cell 106.1, one or more field mappings to be performed by the cell 106.1 (e.g., based on source data obtained as a result of the one or more service calls), and one or more rule sets to be used by cell 106.1 (e.g., in association with generating decision data based on the source data).

As further shown in FIG. 4, process 400 may include performing, based on the service call information included in the configuration, one or more service calls to obtain source data associated with processing the authorization request (block 430). For example, the cell 106 (e.g., using processor 320 and/or memory 330) may perform, based on the service call information included in the configuration, one or more service calls to obtain source data associated with processing the authorization request, as described above in connection with reference 156 of FIG. 1B. As an example, the cell 106.1 may perform one or more service calls that result in the source data (e.g., a credit limit associated with the account credential or the medium credential, a total balance value associated with the account credential or the medium credential, a total outstanding value associated with the account credential or the medium credential, a tokenized medium credential corresponding to the medium credential, or the like) being obtained by the cell 106.1.

As further shown in FIG. 4, process 400 may include performing, based on the source data and the field mapping information included in the configuration, one or more field mappings to generate decision data (block 440). For example, the cell 106 (e.g., using processor 320 and/or memory 330) may perform, based on the source data and the field mapping information included in the configuration, one or more field mappings to generate decision data, as described above in connection with reference 158 of FIG. 1B. As an example, the cell 106.1 may perform one or more field mappings (e.g., data transformations) that provide the cell 106.1 with an OTB value associated with the account credential.

As further shown in FIG. 4, process 400 may include evaluating the decision data based on the one or more rule sets indicated in the configuration to determine an authorization decision associated with the authorization request (block 450). For example, the cell 106 (e.g., using processor 320 and/or memory 330) may evaluate the decision data based on the one or more rule sets indicated in the configuration to determine an authorization decision associated with the authorization request, as described above in connection with reference 162 of FIG. 1B. As an example, the cell 106.1 may evaluate the OTB value to determine an authorization decision associated with the authorization request (e.g., whether the authorization request is approved).

As further shown in FIG. 4, process 400 may include generating an authorization response based on the authorization decision (block 460). For example, the cell 106 (e.g., using processor 320 and/or memory 330) may generate an authorization response based on the authorization decision, as described above in connection with reference 164 of FIG. 1C. As an example, the cell 106.1 may generate an authorization response that includes an indication of whether the authorization request is approved.

As further shown in FIG. 4, process 400 may include providing the authorization response (block 470). For example, the cell 106 (e.g., using processor 320 and/or memory 330) may provide the authorization response, as described above in connection with reference 166 of FIG. 1C. As an example, the cell 106.1 may provide the authorization response to the routing device 104 from which the cell 106.1 received the authorization request.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A device for configuration-driven authorization request processing, the device comprising:
one or more memories; and
one or more processors, communicatively coupled to the one or more memories, configured to:
obtain an authorization request;
retrieve a configuration associated with processing the authorization request, wherein the configuration indicates service call information, field mapping information, and one or more rule sets, wherein the field mapping information is associated with an open-to-buy calculation;
perform, based on the service call information included in the configuration, one or more service calls to obtain source data associated with processing the authorization request;
perform, based on the source data and the field mapping information included in the configuration, one or more field mappings to generate decision data;
evaluate the decision data based on the one or more rule sets indicated in the configuration to determine an authorization decision associated with the authorization request;
generate an authorization response based on the authorization decision; and
provide the authorization response, wherein the authorization response is based on the configuration.

2. The device of claim 1, wherein the configuration indicates a service call condition, and the one or more processors are further configured to determine that the service call condition is satisfied prior to performing the one or more service calls.

3. The device of claim 1, wherein the one or more service calls comprise a plurality of service calls and, based on the configuration, a second service call of the plurality of service calls is performed after a performance of a first service call of the plurality of service calls is completed.

4. The device of claim 1, wherein the one or more service calls comprise a plurality of service calls and, based on the configuration, at least two service calls of the plurality of service calls are performed concurrently.

5. The device of claim 1, wherein the configuration indicates a field mapping condition, and the one or more processors are further configured to determine that the field mapping condition is satisfied prior to performing the one or more field mappings.

6. The device of claim 1, wherein the one or more rule sets include at least one of a base rule set for processing authorization requests or a transaction-division-specific rule set for processing authorization requests.

7. The device of claim 1, wherein the one or more processors are further configured to:
perform, based on the service call information and after evaluating the decision data, one or more post-decision service calls associated with the authorization decision.

8. The device of claim 1, wherein the one or more processors are further configured to:
perform, based on the field mapping information and after evaluating the decision data, one or more post-decision field mappings in association with generating the authorization response.

9. The device of claim 1, wherein at least one of the authorization request, the source data, the decision data, information associated with the authorization decision, or the authorization response are stored in a data map, wherein the data map includes an identifier associated with the authorization request.

10. A method for configuration-driven request processing, comprising:
retrieving, by a device, a configuration associated with processing a request;
performing, by the device and based on service call information included in the configuration, one or more service calls to retrieve input data associated with processing the request;
performing, by the device and based on the input data and field mapping information included in the configuration, one or more field mappings to create output data, wherein the field mapping information is associated with an open-to-buy calculation;
evaluating, by the device, the output data based on one or more rule sets indicated in the configuration to determine a decision associated with the request; and
providing, by the device, a response based on the decision, wherein the response is based on the configuration.

11. The method of claim 10, further comprising determining that a service call condition is satisfied prior to performing the one or more service calls.

12. The method of claim 10, wherein the one or more service calls comprise a plurality of service calls and, based on the configuration, a second service call of the plurality of service calls is performed after a performance of a first service call of the plurality of service calls is completed.

13. The method of claim 10, wherein the one or more service calls comprise a plurality of service calls and, based on the configuration, at least two service calls of the plurality of service calls are performed concurrently.

14. The method of claim 10, further comprising determining that a field mapping condition is satisfied prior to performing the one or more field mappings.

15. The method of claim 10, wherein the one or more rule sets include at least one of a base rule set for processing requests or a transaction-division-specific rule set for processing requests.

16. The method of claim 10, further comprising:
performing, based on the service call information and after evaluating the output data, one or more post-decision service calls associated with the decision.

17. The method of claim 10, further comprising:
performing, based on the field mapping information and after evaluating the output data, one or more post-decision field mappings in association with generating the response.

18. The method of claim 10, wherein at least one of the request, the input data, the output data, information associated with the decision, or the response are stored in a data map, wherein the data map includes an identifier associated with the request.

19. A non-transitory computer-readable medium storing a set of instructions, the set of instructions comprising:
one or more instructions that, when executed by one or more processors of a device, cause the device to:
retrieve a configuration associated with processing an authorization request, wherein the configuration indicates service call information, field mapping information, and one or more rule sets, wherein the field mapping information is associated with an open-to-buy calculation;
perform, based on the service call information included in the configuration, one or more service calls to obtain source data associated with processing the authorization request;
perform, based on the source data and the field mapping information included in the configuration, one or more field mappings to generate decision data;
evaluate the decision data based on the one or more rule sets indicated in the configuration to determine an authorization decision associated with the authorization request;
perform, based on the configuration and after evaluating the decision data, one or more post-decision service calls or one or more post-decision field mappings in association with generating an authorization response; and
provide the authorization response, wherein the authorization response is based on the configuration.

20. The non-transitory computer-readable medium of claim 19, wherein the one or more instructions further cause the device to determine that the service call condition is satisfied prior to performing the one or more service calls.
